(19) United States
(12) Patent Application Publication
(10) Pub. No.: US 2025/0081050 A1
(43) Pub. Date: Mar. 6, 2025

(54) OPTIMAL OR INTELLIGENT SECONDARY CELL SELECTION IN A WIRELESS COMMUNICATIONS O-RAN NETWORK

(71) Applicant: DISH Wireless L.L.C., Englewood, CO (US)

(72) Inventor: Manish Uniyal, Parker, CO (US)

(21) Appl. No.: 18/459,021

(22) Filed: Aug. 30, 2023

(51) Int. Cl. H04W 36/00; H04W 28/02; H04W 36/22

(52) U.S. Cl. CPC H04W 36/0069; H04W 28/0226; H04W 36/00835; H04W 36/00837; H04W 36/22

(57) ABSTRACT

A method for selecting a secondary cell in a wireless communication system for carrier aggregation includes providing at least one parameter for each secondary cell in a plurality of secondary cells that indicates a connection priority for each secondary cell and transmitting a set of parameters for each secondary cell to a UE. The set of parameters for each secondary cell includes the parameter indicating a connection priority for the secondary cell. The method further includes receiving a request from the UE to connect with a secondary cell selected based on the parameter indicating a connection priority for the secondary cell, connecting the selected secondary cell to the UE, and transmitting data to the UE using a primary cell and the selected secondary cell.

### FIELD

The present disclosure relates generally to mobile wireless communication networks and more particularly to wireless communication networks that use carrier aggregation.

### BACKGROUND

Wireless mobile communication technology uses various standards and protocols to transmit data between a base station and user equipment (UE). Wireless wide area network communication system standards and protocols can include, for example, the 3^{rd} Generation Partnership Project (3GPP). Current 3GPP for 5G specifications support specific component carrier bandwidths such as 5 MHz, 10 MHz, 15 MHZ, or 20 MHz. Carrier aggregation (CA) is a technique that has been introduced to allow a wireless communication network to support bandwidths larger than 20 MHz. Carrier aggregation is enabled in 3GPP standards and enables using multiple carriers simultaneously to create a wider channel for data transmission, e.g., multiple component carriers may be assigned to the same UE. This results in increased bandwidth, data rates, and data throughput, and reduced latency. The maximum possible data rate per UE is increased the more component carriers are assigned to the UE.

### SUMMARY

In accordance with an embodiment, a method for selecting a secondary cell in a wireless communication system for carrier aggregation includes providing at least one parameter for each secondary cell in a plurality of secondary cells that indicates a connection priority for each secondary cell and transmitting a set of parameters for each secondary cell to a UE. The set of parameters for each secondary cell includes the parameter indicating a connection priority for the secondary cell. The method further includes receiving a request from the UE to connect with a secondary cell selected based on the parameter indicating a connection priority for the secondary cell, connecting the selected secondary cell to the UE, and transmitting data to the UE using a primary cell and the selected secondary cell.

In accordance wither another embodiment, a method for selecting a secondary cell in a wireless communication system for carrier aggregation includes receiving a request from a UE to connect with a secondary cell, determining a load for each secondary cell in a plurality of secondary cells, determining if the determined load of at least one of the plurality of secondary cells is equal to or greater than a load threshold, selecting one of the secondary cells from the plurality of secondary cells based on the determined load and the load threshold, connecting the selected secondary cell to the UE, and transmitting data to the UE using a primary cell and the selected secondary cell.

In accordance with another embodiment, a base station for a wireless communication system includes a transceiver configured to transmit and receive signal, one or more processor devices coupled to the transceiver and one or more computer readable media. The one or more computer readable media include instructions that, when executed by the one or more processor devices, perform a process including providing at least one parameter for each secondary cell in a plurality of secondary cells that indicates a connection priority for each secondary cell and transmitting a set of parameters for each secondary cell to a UE. The set of parameters for each secondary cell include the parameter indicating a connection priority for the secondary cell. The process further includes receiving a request from the UE to connect with a secondary cell selected based on the parameter indicating a connection priority for the secondary cell, connecting the selected secondary cell to the UE, and transmitting data to the UE using a primary cell and the selected secondary cell.

### BRIEF DESCRIPTION OF THE DRAWINGS

The present disclosure will hereafter be described with reference to the accompanying drawings, wherein like reference numerals denote like elements.

FIG. 1 is a block diagram of a wireless communication system in accordance with an embodiment;

FIG. 2 illustrates a method for selecting a secondary cell in a wireless communication system for carrier aggregation in accordance with an embodiment;

FIG. 3 illustrates a method for selecting a secondary cell in a wireless communication system for carrier aggregation in accordance with an embodiment; and

FIG. 4 illustrates a method for selecting a secondary cell in a wireless communication system for carrier aggregation in accordance with an embodiment.

### DETAILED DESCRIPTION

Carrier aggregation can be used in Radio Access Networks (RANs) and user devices (e.g., user equipment (UE)) to allow Mobile Network Operators (MNOs) to combine the capabilities of radio cells to enhance end user experience. Each carrier has specific characteristics in terms of coverage (the range around the antenna where signal can still be received) and capacity (bandwidth, data rates, throughput). Carriers in the higher capacity ranges typically provide greater capacity, while carriers in the lower range provide wider and deeper coverage. The mid-band frequencies are known to provide a good combination of capacity and coverage. Traditionally, three types of carrier aggregation have been utilized: intraband contiguous carrier aggregation, intraband noncontiguous carrier aggregation, and interband carrier aggregation. Intraband contiguous carrier aggregation corresponds to a situation in which the component carriers are in the same frequency band and contiguous of each other, i.e., one component carrier begins where the other component carrier ends. Intraband noncontiguous carrier aggregation corresponds to a situation in which component carriers are in the same frequency band but separated by a gap. Interband carrier aggregation corresponds to a situation in which the component carriers are in different frequency bands.

A UE may simultaneously receive or transmit on one or on a plurality of component carriers (CCs) depending on its capabilities. Carrier aggregation enables a plurality of component carriers to be assigned to the same UE which results in, for example, an increase of the bandwidth and data rate. Accordingly, the two or more component carriers are aggregated, for example, 5G New Radio (NR) supports carrier aggregation with 16 component carriers. Carrier aggregation of carriers of networks utilizing different Radio Access Technology (RAT), for example, carrier aggregation of LTE and 5G NR carriers, may also be possible and is known as Dual Connectivity (DC). The maximum possible bandwidth data rate per UE is increased the more component carriers are assigned to the UE. In carrier aggregation, the UE is camped to only one serving cell called the Primary Serving Cell (PCell) and the component carrier serving the PCell is called the Primary component carrier (PCC). The PCell may be used for signaling and control information and data. The other component carriers are referred to as the Secondary component carriers (SCC) and each secondary component carrier serves a corresponding Secondary Serving Cell (SCell). Each SCell may be used for data only.

In a network with three or more component carriers for carrier aggregation, there can be two or more component carriers available to be used for secondary serving cells (SCells). For example, in a network with three serving cells (and corresponding component carriers), for carrier aggregation there will be one primary serving cell (PCell) and a first SCell and a second SCell. Each of the SCells (i.e., the secondary component carrier serving each SCell) can have different bandwidths, for example, a first SCell may have a higher bandwidth than the second SCell. In addition, the load on each available Sell may vary at different points in time, for example, at a given point in time the first SCell, may have a higher load than the second SCell. Accordingly, when more than one S Cell is available for carrier aggregation, it may be desirable to select an available SCell that will ensure a good user experience, for example, higher throughput, no interruptions or buffering, faster speeds, etc.

The present disclosure describes a system and method for selecting a secondary cell for carrier aggregation. In some embodiments, the disclosed systems and methods can enable selection of an optimal SCell or SCells for carrier aggregation when more than one SCell is available in a wireless communication network. In some embodiments, a parameter may be provided for each SCell that indicates a connection priority for the SCell. For example, if s first SCell has a higher bandwidth than a second SCell, the parameter may indicate a priority for the first SCell. In some embodiments, the parameter may be a time-to-trigger and a shorter time-to-trigger may be provided for first SCell with the higher bandwidth than for the second SCell with the lower bandwidth. In some embodiments, a load of each available SCell may be determined and a UE may be connected to the SCell with the lower or no load. In some embodiments, both an SCell parameter indicating a connection priority and a determination of the current load on each SCell can be used to select an available SCells for carrier aggregation. Selecting an optimal or best SCell for carrier aggregation can help provide improved performance, for example, downlink (DL) performance, and user experience. In some embodiments, the disclosed system and method for selecting a secondary cell can also help with setting up downlink carrier aggregation priorities in the network.

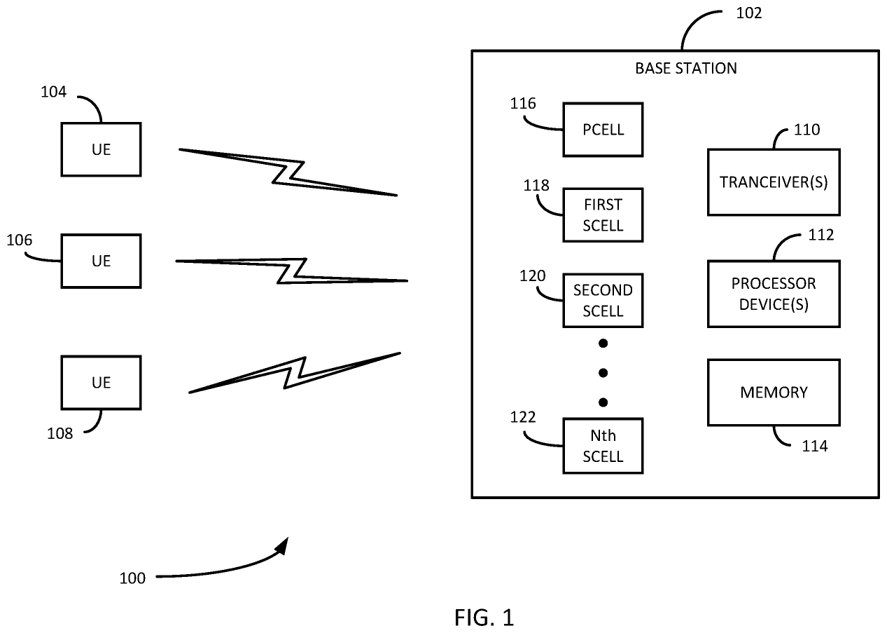

FIG. 1 is a block diagram of a wireless communication system in accordance with an embodiment. The wireless communication system 100 can include a base station 102 and user equipment (UE), for example, UE 104, UE 106, and UE 108. The base station 102 can enable a UE (e.g., US 102, US 104 and/or UE 108) to, for example, communicate with other UEs or to send and receive data via the Internet. In some embodiments, the wireless communication system 100 can be a 3GPP network. Base station 102 can serve as a Radio Access Network (RAN) or an Open Radio Access Network (O-RAN). In some embodiments, the radio access technology (RAT) used by the wireless communication system 100 to communicate with the UE 104, 106, 108 can be a fifth generation (5G) new radio (NR) network and the base station 102 can include a gNode B. In some embodiments, the wireless communication system 100 can operate according to a different RAT such as, for example, a 4G Long Term Evolution (LTE) network. In an example with a 4G LTE RAT, the base station 102 can include an eNodeB. While the following description will refer to a 5G NR network and an gNodeB, it should be understood that other radio access technologies may be implemented in the wireless communication system 100. While FIG. 1 illustrates various components of wireless communication system 100, other embodiments of wireless communication system 100 can vary the arrangement, communication paths, and specific components of wireless communication system 100.

The base station 102 can include one or more transceiver(s) 110, one or more processor device(s) 112, and memory (or data storage) 114. The transceiver(s) 110 can transmit and receive mobile communication signals to a UE, for example, UE 104, to other base stations, and to other communication systems to enable mobile communication and access to the Internet. The memory 114 can include one or more non-transitory computer readable media that store software instructions for establishing a mobile communication network with the base station 102. The processor device(s) 112 can execute the instructions stored on the one or more non-transitory computer readable media of the memory 114. As set forth in more detail below, executing the software instructions can cause the base station 102 to perform a process for selection of a secondary cell (SCell) for carrier aggregation.

The base station 102 may support a plurality of component carriers (CCs) that each correspond to a serving cell, for example, a primary serving cell (PCell) 116 and a plurality of secondary serving cells (SCells) 118, 120, 122. PCell 116 may be served by a primary component carrier (PCC) and each SCell 118, 120, 122 may be served by a secondary component carrier (SCC). In FIG. 1, N SCells are illustrated, a first SCell 118, a second SCell 120, and an Nth SCell 122. While the following description will refer to two SCells (N=2) for simplicity, e.g., a first SCell 118 and a second SCell 120), it should be understood that other numbers of SCells may be supported by the base station 102. Each SCell 118, 120, 122 (and its corresponding secondary component carrier) may be available for carrier aggregation with a UE 104, 106, 108. In some embodiments, each SCell 118, 120, 122 (i.e., the secondary component carrier for each SCell) may have a different bandwidth. For example, the first SCell 118 may have a greater bandwidth than the second SCell 120. In some embodiments, the primary serving cell 116 may be utilized to provide signaling and control information as well as data packets and each secondary cell 118, 120, 122 can be used to provide only data packets. Accordingly, in such embodiments, the signaling and control information may be provided exclusively on the primary cell 116. In addition, the primary serving cell 116 can be used to establish an initial connection with a UE 104, 106, 108. While FIG. 1 illustrates the serving cells 118, 120, and 122 (and associated component carriers) being supported and associated with the same base station 102, in some embodiments, one or more of the serving cells 118, 120, 122 may supported by a different base station (not shown).

As mentioned, the wireless communication system 100 can also include a plurality of UEs 104, 106, 108. The UEs 104, 106, 108 can be various forms of wireless devices that are capable of communication according to the RAT of the wireless communication system 100. For example, in some embodiments, the UEs 104, 106, 108 can be smartphones, wireless modems, cellular phones, laptop computers, wireless access points (APs), etc. After the base station 102 and a UE, for example, UE 104, have established a connection, the base station 102 can provide data (e.g., data packets) to the UE 104 and can receive data from the UE 104. In some embodiments, the data can include, for example, voice data for a phone call, data provided by a web server to the UE 104, data provided by the UE 104 to a web server, or other types of data commonly exchanged on wireless communication networks. For example, after the UE has established a connection with the base station 102, a user of the UE 104 may select to stream a video on an application of the UE 104 via the Internet. The video stream can be provided to the UE 104 on data packets from the base station 102.

In some embodiments, one or more of the UE 104, 106, 108 may be capable of or configured for carrier aggregation with various numbers of component carriers (CCs). For example, a UE capable of carrier aggregation with two component carriers (“2 CC”) can utilize one primary cell and one secondary cell, a UE capable of carrier aggregation with three component carriers (“3 CC”) can utilize one primary cell and up to two secondary cells, a UE capable of carrier aggregation with four component carriers (“4 CC”) can utilize one primary cell and up to three secondary cells, and so on. As mentioned above, for a UE capable of carrier aggregation (i.e., utilizing at least two component carriers), when more than one secondary cell is available it can be advantageous to select an optimal secondary cell for carrier aggregation.

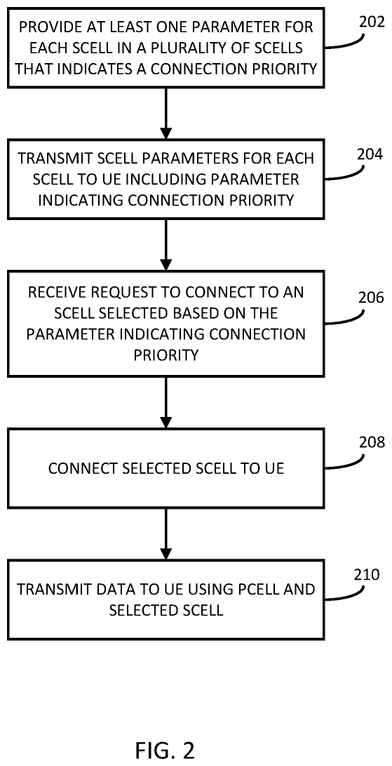

FIG. 2 illustrates a method for selecting a secondary cell in a wireless communication system for carrier aggregation in accordance with an embodiment. The process illustrated in FIG. 2 is described below as being carried out by the wireless communication system 100 as illustrated in FIG. 1. Although the blocks of the process are illustrated in a particular order, in some embodiments, one or more blocks may be executed in a different order than illustrated in FIG. 1, or may be bypassed.

At block 202, at least one parameter (or parameter value) that indicates a connection priority for a secondary cell may be provided for each secondary cell (SCell) 118, 120, 122 in a plurality of secondary cells supported by one or more base stations 102 in a wireless communication network or system 100. In some embodiments, the parameter may be given a predetermined value the indicates a preference for connection to or use of the particular SCell for carrier aggregation. As mentioned above, a base station 102 may support more than one SCell for carrier aggregation and each available SCell may have a different bandwidth, for example, a first SCell 118 may have a greater bandwidth than a second SCell 120. In one example, the primary serving cell (PCell) 116 may have a bandwidth of 10 MHz, the first secondary serving cell (SCell) 118 may have a bandwidth of 20 MHz, and the second secondary serving cell (SCell) 120 may have a bandwidth of 15 MHz. In some embodiments, it may be desirable, e.g., for improved user experience and performance, to utilize the first SCell 118 with the greater bandwidth (20 MHz) for carrier aggregation which, this this example, would result in a bandwidth of 30 MHz for data transmission using the aggregated PCell 116 and first SCell 118. Accordingly, in this example, the value of the parameter for the first SCell 118 may be set to indicate a preference for the first SCell 118 for carrier aggregation.

In some embodiments, the parameter may be a time-to-trigger (TTT) for the SCell. The time-to-trigger is the time during which specified criteria for an event needs to be met in order to trigger a measurement report by a UE 104 to the base station 102. In some embodiments, the time-to-trigger value for the preferred SCell may be a shorter time-to-trigger than the time-to-trigger value of the other available SCells. For example, if the first SCell 118 has a higher bandwidth (as discussed in the example above) than the second SCell 120, the time-to-trigger value for the first SCell 118 may be set to be shorter (e.g., 100 ms) than the time-to-trigger value (e.g., 160 ms) of the second SCell 120. Accordingly, the time-to-trigger value can indicate a connection priority or preference in carrier aggregation for the SCell with the higher bandwidth.

At block 204, a set of SCell parameters for each available SCell which includes the parameter indicating a connection priority may be transmitted to a UE (e.g., UE 104). The sets of SCell parameters for the plurality of SCells supported by the base station 102 may be transmitted from the base station 102 to the UE, e.g., UE 104, using messages in accordance with a signaling protocol. In some embodiments, the signaling protocol can be the Radio Resource Control (RRC) protocol which is a layer 3 (Network Layer) protocol used between the UE 104 and the base station 102. In some embodiments, an RRC Connection Reconfiguration message and procedure to transmit the sets of SCell parameters to the UE 104. The RRC Connection Reconfiguration message can be used by the base station 102 to command a modification of an RRC connection and may be used to add, modify, or release SCells and establish carrier aggregation. RRC messages can be handled by the primary serving cell 116 for the UE 104.

At block 206, the base station 102 may receive a request to connect to an SCell that may be selected based in the parameter indicating a connection priority. The request may be received from, for example, the UE 104. In some embodiments, a message may be received from the UE 104 that is configured to initiate the connection of the selected SCell to the UE 104 for carrier aggregation. In some embodiments, the request may be (or be part of) an RRC message such as, for example, an RRC Connection Reconfiguration Complete message or an RRC measurement report. For example, the UE 104 may be configured to determine or measure a signal strength of each of the plurality of SCells 118, 120, 122 supported by the base station 102. In some embodiments, the US 104 may determine or measure a reference signal received power (RSRP) of the secondary serving cell. When the RSRP exceeds a predetermined threshold, the UE may transmit a measurement report to base station 102. In some embodiments, the measurement reporting event may be an A4 event that occurs when a neighbor cell (e.g., first SCell 118 or second SCell 120) exceeds the predetermined threshold. For example, the predetermined threshold may be −110 dBm for the first SCell 118 and the second SCell 120. The measurement reporting event can trigger a measurement report when the threshold and time-to-trigger requirements are met, for example, when the UE enters a measurement report event (e.g., an A4 event), the UE can start a timer with the TTT value and when the timer expires the UE 104 can transmit the measurement report to the UE. In the example discussed above, the first SCell 118 can have a higher bandwidth and may be given a TTT value of 100 ms while the second SCell can have a lower bandwidth and may be given a TTT value of 160 ms. Accordingly, the measurement report for the first SCell 118 can be transmitted to the base station 102 earlier than the measurement report of the second SCell 120.

At block 208, the base station 102 may connect the selected SCell to the UE 104. As mentioned above with regard to block 206, a message may be received from the UE 104 that is configured to initiate the connection of the selected SCell to the UE 104 for carrier aggregation. In some embodiments, the message can be an RRC measurement report. For example, the base station 102 can base the decision to use the SCell associated with the measurement report (e.g., a first SCell 118 with a higher bandwidth and the shorter TTT value) based on information in the measurement report received from the UE 104. At block 210, after establishing a connection between the selected SCell (e.g., first SCell 118) and the UE 104, the base station 102 may transmit data to the UE 104 using the primary cell 116 and the selected SCell (e.g., first SCell 118).

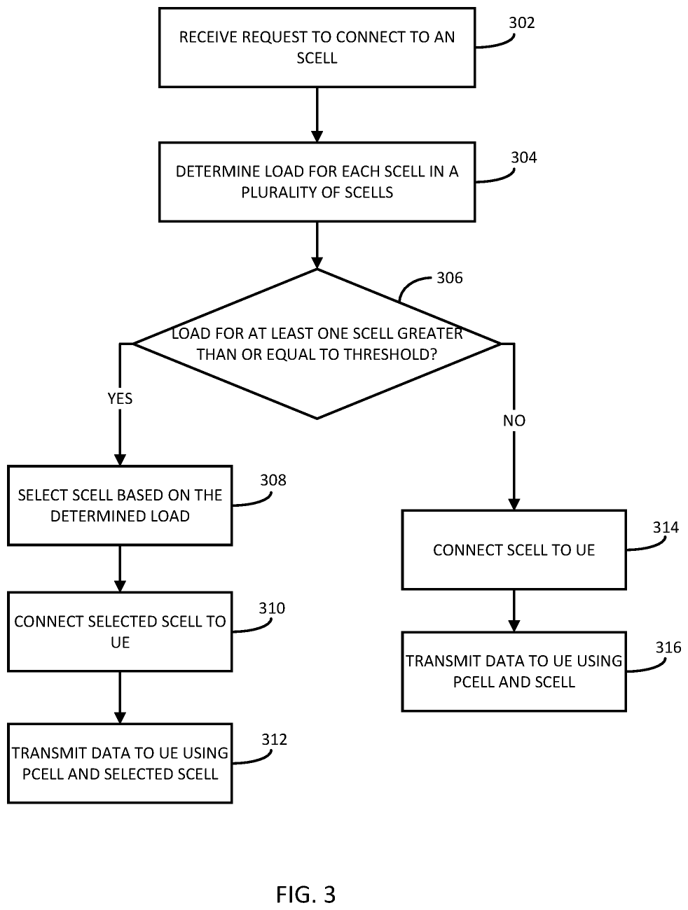

FIG. 3 illustrates a method for selecting a secondary cell in a wireless communication system for carrier aggregation in accordance with an embodiment. The process illustrated in FIG. 3 is described below as being carried out by the wireless communication system 100 as illustrated in FIG. 1. Although the blocks of the process are illustrated in a particular order, in some embodiments, one or more blocks may be executed in a different order than illustrated in FIG. 3, or may be bypassed.

At block 302, a base station 102 may receive a request to connect a UE 104 to an SCell. The request may be received from, for example, the UE 104. In some embodiments, a message may be received from the UE 104 that is configured to initiate the connection of an available SCell (e.g., SCells 118, 120, 122) to the UE 104 for carrier aggregation. In some embodiments, the request may be (or be part of) an RRC message such as, for example, an RRC Connection Reconfiguration Complete message or an RRC measurement report. For example, the UE 104 may be configured to determine or measure a signal strength of each of the plurality of SCells 118, 120, 122 supported by the base station 102. In some embodiments, the UE 104 may determine or measure a reference signal received power (RSRP) of the secondary serving cell.

When the RSRP exceeds a predetermined threshold, the UE may transmit a measurement report to base station 102. In some embodiments, the measurement reporting event may be an A4 event that occurs when a neighbor cell (e.g., first SCell 118 or second SCell 120) exceeds the predetermined threshold. For example, the predetermined threshold may be −110 dBm. The measurement reporting event can trigger a measurement report when the threshold and time-to-trigger requirements are met, for example, when the UE enters a measurement report event (e.g., an A4 event), the UE can start a timer with the TTT value and when the timer expires the UE 104 can transmit the measurement report to the UE.

At block 304, the base station 102 may determine a current load for each of the available SCells. As mentioned above, a plurality of UEs 104, 106, 108 may be connected to base station 102. In some embodiments, the base station 102 may be configured to determine the load of an available SCell supported by the base station 102 by determining the total number of carrier aggregation (CA) capable UEs that are connected to the PCell 116 and then determining the number of CA capable UEs that are connected to each of the available SCells, or a percentage of the total number of CA capable UE's that are connected to each SCell. At block 306, it can be determined whether the load of at least one of the SCells (e.g., SCells 118, 120, 122) exceeds a predetermined load threshold. In some embodiments, the predetermined load threshold may be a certain percentage of the CA capable UEs being connected to a particular SCell. For example, in some embodiments, the predetermined load threshold may be 75-85% of the CA capable UEs being connected to a particular SCell. In an example, for a base station with two SCells (e.g., first SCell 118 and second SCell 120), 80 CA capable SCells connected to PCell 116 and a predetermined load threshold of 75%, the load threshold will be met if 60 of the CA capable UEs are connected to the first SCell 118 and 20 of the CA capable UEs are connected to the second SCell 120. If the load of at least one SCell meets the load threshold at block 306, then an SCell may be selected at block 308 based on the determined load for each of the SCells 118, 120, 122 supported by the base station 102. In some embodiments, an SCell may be selected that has the lowest load or no load. For example, there may be two available SCells, namely, first SCell 118 and second SCell 120. If the second SCell 120 has a less load or no load compared to the load of the first SCell 118, the base station 102 may select the second SCell 120 for carrier aggregation. In the example described above, with a load threshold of 75% and a load on the first SCell 118 of 60 CA capable UEs and a load on the second SCell 120 of 20 CAC capable UEs, the second SCell 120 may be selected for the UE, e.g., UE 104, making the current request. Accordingly, an Skel for carrier aggregation for a particular UE can be selected based on the number of CA capable UEs attached to each available SCell. At block 310, the base station 102 may connect the selected SCell to the UE 104. In some embodiments, the base station 102 may use RRC signaling message protocol to connect the selected SCell to the UE. At block 312, after establishing a connection between the selected SCell (e.g., first SCell 118) and the UE 104, the base station 102 may transmit data to the UE 104 using the primary cell 116 and the selected SCell (e.g., first SCell 118).

Returning to block 306, if the load of at least one SCell does not meet the load threshold, then the base station 102 may connect the UE 104 making the request to one of the available SCells. For example, the UE 104 may connect to one of the available SCells based on a schedule. In some embodiments, the base station 102 may use RRC signaling message protocol to connect the SCell to the UE. At block 316, after establishing a connection between an SCell (e.g., first SCell 118) and the UE 104, the base station 102 may transmit data to the UE 104 using the primary cell 116 and the SCell (e.g., first SCell 118).

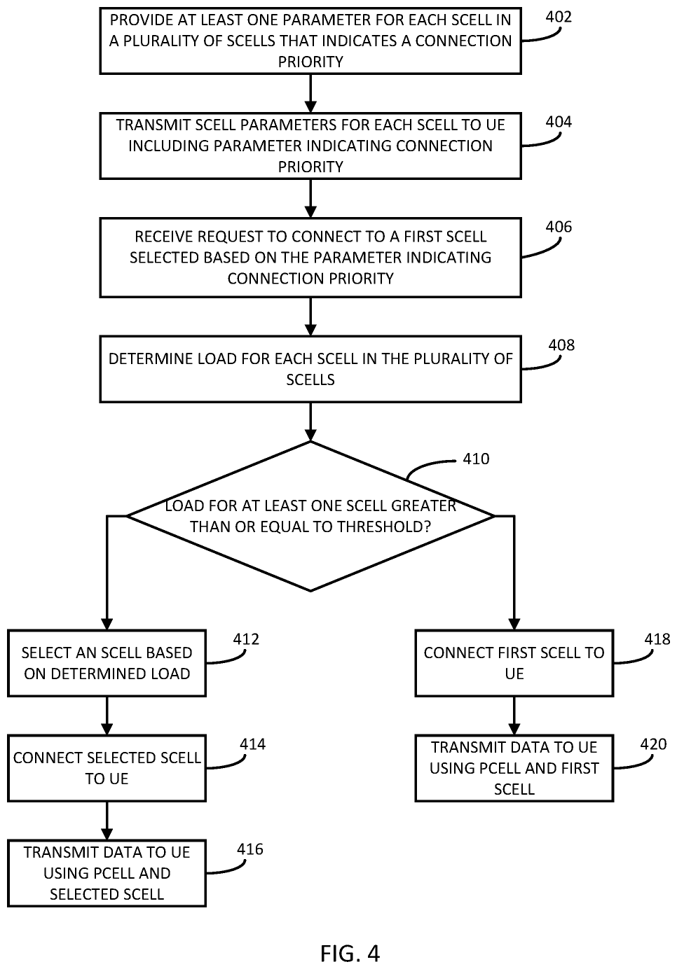

In some embodiments, both an SCell parameter indicating a connection priority and a determination of the current load on each SCell can be used to select an available SCell for carrier aggregation. FIG. 4 illustrates a method for selecting a secondary cell in a wireless communication system for carrier aggregation in accordance with an embodiment. The process illustrated in FIG. 4 is described below as being carried out by the wireless communication system 100 as illustrated in FIG. 1. Although the blocks of the process are illustrated in a particular order, in some embodiments, one or more blocks may be executed in a different order than illustrated in FIG. 4, or may be bypassed.

At block 402, at least one parameter (or parameter value) that indicates a connection priority for a secondary cell may be provided for each secondary cell (SCell) 118, 120, 122 in a plurality of secondary cells supported by one or more base stations 102 in a wireless communication network or system 100. In some embodiments, the parameter may be given a predetermined value the indicates a preference for connection to or use of the particular SCell for carrier aggregation. As mentioned above, a base station 102 may support more than one SCell for carrier aggregation and each available SCell may have a different bandwidth, for example, a first SCell 118 may have a greater bandwidth than a second SCell 120. In one example, the primary serving cell (PCell) 116 may have a bandwidth of 10 MHz, the first secondary serving cell (SCell) 118 may have a bandwidth of 20 MHz, and the second secondary serving cell (SCell) 120 may have a bandwidth of 15 MHz. In some embodiments, it may be desirable, e.g., for improved user experience and performance, to utilize the first SCell 118 with the greater bandwidth (20 MHz) for carrier aggregation which, in this example, would result in a bandwidth of 30 MHz for data transmission using the aggregated PCell 116 and first SCell 118. Accordingly, in this example, the value of the parameter for the first SCell 118 may be set to indicate a preference for the first SCell 118 for carrier aggregation.

In some embodiments, the parameter may be a time-to-trigger (TTT) for the SCell. The time-to-trigger is the time during which specified criteria for an event needs to be met in order to trigger a measurement report by a UE 104 to the base station 102. In some embodiments, the time-to-trigger value for the preferred SCell may be a shorter time-to-trigger than the time-to-trigger value of the other available SCells. For example, if the first SCell 118 has a higher bandwidth (as discussed in the example above) than the second SCell 120, the time-to-trigger value for the first SCell 118 may be set to be shorter (e.g., 100 ms) than the time-to-trigger value (e.g., 160 ms) of the second SCell 120. Accordingly, the time-to-trigger value can indicate a connection priority or preference in carrier aggregation for the SCell with the higher bandwidth.

At block 404, a set of SCell parameters for each available SCell which includes the parameter indicating a connection priority may be transmitted to a UE (e.g., UE 104). The sets of SCell parameters for the plurality of SCells supported by the base station 102 may be transmitted from the base station 102 to the UE, e.g., UE 104, using messages in accordance with a signaling protocol. In some embodiments, the signaling protocol can be the Radio Resource Control (RRC) protocol which is a layer 3 (Network Layer) protocol used between the UE 104 and the base station 102. In some embodiments, an RRC Connection Reconfiguration message and procedure to transmit the sets of SCell parameters to the UE 104. The RRC Connection Reconfiguration message can be used by the base station 102 to command a modification of an RRC connection and may be used to add, modify, or release SCells and establish carrier aggregation. RRC messages can be handled by the primary serving cell 116 for the UE 104.

At block 406, the base station 102 may receive a request to connect to an SCell that may be selected based in the parameter indicating a connection priority. The request may be received from, for example, the UE 104. In some embodiments, a message may be received from the UE 104 that is configured to initiate the connection of the selected SCell to the UE 104 for carrier aggregation. In some embodiments, the request may be (or be part of) an RRC message such as, for example, an RRC Connection Reconfiguration Complete message or an RRC measurement report. For example, the UE 104 may be configured to determine or measure a signal strength of each of the plurality of SCells 118, 120, 122 supported by the base station 102. In some embodiments, the UE 104 may determine or measure a reference signal received power (RSRP) of the secondary serving cell. When the RSRP exceeds a predetermined threshold, the UE may transmit a measurement report to base station 102. In some embodiments, the measurement reporting event may be an A4 event that occurs when a neighbor cell (e.g., first SCell 118 or second SCell 120) exceeds the predetermined threshold. For example, the predetermined threshold may be −110 dBm for the first SCell 118 and the second SCell 120. The measurement reporting event can trigger a measurement report when the threshold and time-to-trigger requirements are met, for example, when the UE enters a measurement report event (e.g., an A4 event), the UE can start a timer with the TTT value and when the timer expires the UE 104 can transmit the measurement report to the UE. In the example discussed above, the first SCell 118 can have a higher bandwidth and may be given a TTT value of 100 ms while the second SCell can have a lower bandwidth and may be given a TTT value of 160 ms. Accordingly, the measurement report for the first SCell 118 can be transmitted to the base station 102 earlier than the measurement report of the second SCell 120.

At block 408, the base station 102 may determine a current load for each of the available SCells including the SCell initially selected based on the parameter indicating a connection priority at block 406. As mentioned above, a plurality of UE 104, 106, 108 may be connected to base station 102. In some embodiments, the base station 102 may be configured to determine the load of an available SCell supported by the base station 102 by determining the total number of carrier aggregation (CA) capable UEs that are connected to the PCell 116 and then determining the number of CA capable UEs that are connected to each of the available SCells, or a percentage of the total number of CA capable UE's that are connected to each SCell. At block 410, it can be determined whether the load of at least one of the SCells (e.g., SCells 118, 120, 122) exceeds a predetermined load threshold. In some embodiments, the predetermined load threshold may be a certain percentage of the CA capable UEs being connected to a particular SCell. For example, in some embodiments, the predetermined load threshold may be 75-85% of the CA capable UEs being connected to a particular SCell. In an example, for a base station with two SCells (e.g., first SCell 118 and second SCell 120), 80 CA capable SCells connected to PCell 116 and a predetermined load threshold of 75%, the load threshold will be met if 60 of the CA capable UEs are connected to the first SCell 118 and 20 of the CA capable UEs are connected to the second SCell 120.

If the load of at least one SCell meets the load threshold at block 410, then an SCell may be selected at block 412 based on the determined load for each of the SCells 118, 120, 122 supported by the base station 102 including the SCell initially selected based on the parameter indicating a connection priority at block 406. In some embodiments, an SCell may be selected that has the lowest load or no load. For example, there may be two available SCells, namely, the initially selected SCell, first SCell 118, and second SCell 120. If the second SCell 120 has less load or no load compared to the load of the first SCell 118, the base station 102 may select the second SCell 120 for carrier aggregation. In the example described above, with a load threshold of 75% and a load on the first SCell 118 of 60 CA capable UEs and a load on the second SCell 120 of 20 CAC capable UEs, the second SCell 120 may be selected for the UE, e.g., UE 104, making the current request. If the second SCell 120 does not have less load or no load compared to the first SCell 118, the base station may use the first SCell 118 for carrier aggregation at block 418 based on its initial selection based on the parameter indicating a connection priority at block 406. At block 414, the base station 102 may connect the selected SCell to the UE 104. In some embodiments, the base station 102 may use RRC signaling message protocol to connect the selected SCell to the UE. At block 416, after establishing a connection between the selected SCell (e.g., second SCell 120) and the UE 104, the base station 102 may transmit data to the UE 104 using the primary cell 116 and the selected SCell (e.g., second SCell 120).

Retuning to block 410, if the load of at least one SCell does not meet the load threshold (or as mentioned above, if the other available SCells do not have less load or no load compared to the first SCell 118 selected based on the parameter indicating connection priority), then at block 418 the base station 102 may connect the UE 104 to the first SCell that was selected at block 406 based on the parameter indicating connection priority. In some embodiments, the base station 102 may use RRC signaling message protocol to connect the first SCell to the UE. At block 420, after establishing a connection between the first SCell (e.g., first SCell 118) and the

UE 104, the base station 102 may transmit data to the UE 104 using the primary cell 116 and the first SCell.

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.

Certain operations of methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A method for selecting a secondary cell in a wireless communication system for carrier aggregation, the method comprising:
providing at least one parameter for each secondary cell in a plurality of secondary cells that indicates a connection priority for each secondary cell;
transmitting a set of parameters for each secondary cell to a UE, the set of parameters for each secondary cell including the parameter indicating a connection priority for the secondary cell;
receiving a request from the UE to connect with a secondary cell selected based on the parameter indicating a connection priority for the secondary cell;
connecting the selected secondary cell to the UE; and
transmitting data to the UE using a primary cell and the selected secondary cell.

2. The method according to claim 1, wherein the at least one parameter indicating a connection priority is a time-to-trigger.

3. The method according to claim 2, wherein the plurality of secondary cells comprises a first secondary cell with a first time-to-trigger and a second secondary cell with a second time-to-trigger that is longer than the first time to trigger.

4. The method according to claim 3, wherein the first secondary cell has a larger bandwidth than a bandwidth of the second secondary cell.

5. The method according to claim 1, wherein the plurality of secondary cells comprises a first secondary cell and a second secondary cell and wherein the secondary cell selected based on the parameter indicating a connection priority is the first secondary cell, the method further comprising:
determining a load for the first secondary cell and the second secondary cell;
determining if the determined load of the first secondary cell and the second secondary cell is equal to or greater than a load threshold; and
selecting one of the first secondary cell or the second secondary cell based on the determined load and the load threshold.

6. The method according to claim 5, wherein selecting one of the first secondary cell or the second secondary cell based on the determined load comprises selecting the secondary cell with the lowest load or no load.

7. The method according to claim 1, wherein the primary cell and the selected secondary cell have different bandwidths.

8. The method according to claim 1, wherein the primary cell and the selected secondary have different uplink bandwidths and different downlink bandwidths.

9. The method according to claim 1, wherein the wireless communication system is a 5G new radio (NR) communication system.

10. A method for selecting a secondary cell in a wireless communication system for carrier aggregation, the method comprising:
receiving a request from a UE to connect with a secondary cell;
determining a load for each secondary cell in a plurality of secondary cells;
determining if the determined load of at least one of the plurality of secondary cells is equal to or greater than a load threshold;
selecting one of the secondary cells from the plurality of secondary cells based on the determined load and the load threshold;
connecting the selected secondary cell to the UE; and
transmitting data to the UE using a primary cell and the selected secondary cell.

11. The method according to claim 10, wherein selecting one of the secondary cells from the plurality of secondary cells based on the determined load comprises selecting the secondary cell with the lowest load or no load.

12. The method according to claim 10, wherein the primary cell and the selected secondary cell have different bandwidths.

13. The method according to claim 10, wherein the wireless communication system is a 5G new radio (NR) communication system.

14. A base station for a wireless communication system, the base station comprising:
a transceiver configured to transmit and receive signals;
one or more processor devices coupled to the transceiver; and
one or more computer readable media including instructions that, when executed by the one or more processor devices, perform a process comprising:
providing at least one parameter for each secondary cell in a plurality of secondary cells that indicates a connection priority for each secondary cell;
transmitting a set of parameters for each secondary cell to a UE, the set of parameters for each secondary cell including the parameter indicating a connection priority for the secondary cell;
receiving a request from the UE to connect with a secondary cell selected based on the parameter indicating a connection priority for the secondary cell;
connecting the selected secondary cell to the UE; and
transmitting data to the UE using a primary cell and the selected secondary cell.

15. The base station according to claim 14, wherein the at least one parameter indicating a connection priority is a time-to-trigger.

16. The base station according to claim 15, wherein the plurality of secondary cells comprises a first secondary cell with a first time-to-trigger and a second secondary cell with a second time-to-trigger that is longer than the first time to trigger.

17. The base station according to claim 16, wherein the first secondary cell has a larger bandwidth than a bandwidth of the second secondary cell.

18. The base station according to claim 14, wherein the plurality of secondary cells comprises a first secondary cell and a second secondary cell and wherein the secondary cell selected based on the parameter indicating a connection priority is the first secondary cell, the process further comprising:
determining a load for the first secondary cell and the second secondary cell;
determining if the determined load of the first secondary cell and the second secondary cell is equal to or greater than a load threshold; and
selecting one of the first secondary cell or the second secondary cell based on the determined load and the load threshold.

19. The base station according to claim 18, wherein selecting one of the first secondary cell or the second secondary cell based on the determined load comprises selecting the secondary cell with the lowest load or no load.

20. The base station according to claim 14, wherein the wireless communication system is a 5G new radio (NR) communication system.
